(19) United States
(12) Patent Application Publication
(10) Pub. No.: US 2006/0249053 A1
(43) Pub. Date: Nov. 9, 2006

(54) Cement admixture

(75) Inventors: Hideyuki Sugaya, Oita (JP); Kenichi Honma, Chiba (JP); Makihiko Ichikawa, Chiba (JP); Daisuke Sawaki, Chiba (JP); Shuuichi Harasawa, Chiba (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TAIHEIYO CEMENT CORPORATION, TOKYO (JP)

(21) Appl. No.: 10/545,689

(22) PCT Filed: Mar. 3, 2003
(86) PCT No.: PCT/JP03/02427

§ 371 Date: Aug. 15, 2005

(51) Int. Cl. C04B 28/06; C04B 7/32; C04B 28/04; C04B 14/00; C04B 18/18

(52) U.S. Cl. 106/692; 106/693; 106/695; 106/697; 106/713; 106/732; 106/735

(57) ABSTRACT

A burned product containing 100 parts by weight of C₂S and 10 to 100 parts by weight in total of C₃A and C₄AF, a cement admixture obtained by grinding the burned product, and a cement containing 100 parts by weight of a ground Portland cement clinker and 5 to 100 parts by weight of the burned product. The cement is good in both initial strength and long-term strength.

### TECHNICAL FIELD

This invention relates to a burned product suitable as a cement admixture for a cement good in both initial strength and long-term strength.

### BACKGROUND ART

Conventionally, limestone powder, blast furnace slag powder and the like have been used as cement admixtures. The addition of such an admixture to Portland cement clinker makes it possible to lower the cost for the production of cement.

The use of limestone powder as an admixture, however, is accompanied by a problem that the resulting cement is inferior in long-term strength although its initial strength is comparable with Portland cement. The use of blast furnace slag powder, on the other hand, involves a problem that the resulting cement is inferior in initial strength although its long-term strength is comparable with Portland cement.

An object of the present invention is, therefore, to provide a cement admixture for a cement excellent in both initial strength and long-term strength.

### DISCLOSURE OF THE INVENTION

Under these circumstances, the present inventors have proceeded with extensive research, and found that a burned product, which contains C₂S (2CaO.SiO₂), C₃A(3CaO.Al₂O₃) and C₄AF(4CaO.Al₂O₃.Fe₂O₃) in specific proportions, is suitable as a cement admixture for a cement excellent in both initial strength and long-term strength, and completed the present invention.

Specifically, the present invention provides a burned product comprising 100 parts by weight of C₂S and 10 to 100 parts by weight in total of C₃A and C₄AF, and a cement admixture obtained by grinding the burned product.

The present invention also provides a cement comprising 100 parts by weight of a Portland cement clinker and 5 to 100 parts by weight of a ground product of the burned product.

### BEST MODES FOR CARRYING OUT THE INVENTION

The burned product according to the present invention contains C₂S, C₃A and C₄AF, and comprises, per 100 parts by weight of C₂S, 10 to 100 parts by weight, preferably 50 to 70 parts by weight of C₃A and C₄AF in total. A total amount smaller than 10 parts by weight although excellent in strength, can hardly reduce the amount of free lime to face a difficulty in performing clinkering even if the burning temperature is raised upon clinkering. A total amount greater than 100 parts by weight, on the other hand, cannot develop sufficient initial strength.

Concerning the proportions of C₃A and C₄AF, it is preferred to contain 10 to 200 parts by weight of C₄AF per 100 parts by weight of C₃A, especially 100 to 150 parts by weight of C₄AF per 100 parts by weight of C₃A.

The burned product of such a composition can be produced, for example, by using as a raw material at least one material selected from an industrial waste, a non-industrial waste or surplus soil from a construction site and burning it. Examples of the industrial waste include coal ash; various sludges such as ready-mixed concrete sludge, sewage sludge, water purification sludge, construction sludge, and iron-making sludge; waste mud from drilling; various incineration ashes; foundry sand; rock wool; waste glass; and secondary ash from blast furnaces. Examples of the non-industrial waste include dry ash of sewage sludge, incineration ash of urban garbage, and shells. Further, examples of the surplus soil from the construction site include soil and surplus soil from building sites and construction sites, and also waste soil.

The burning temperature upon clinkering such a raw material can range preferably from 1,000 to 1,350° C., especially from 1,200 to 1,330° C., because melt phases remain in a good state during the clinkering step.

No particular limitation is imposed on an apparatus to be used. For example, a rotary kiln or the like can be used. When clinkering through a rotary kiln, a fuel-substitute waste, for example, waste oil, waste tires, waste plastics or the like can be used.

The cement admixture according to the present invention is obtained by grinding the burned product obtained as described above. Gypsum may be incorporated as much as 1 to 6 parts by weight as calculated in terms of SO₃ per 100 parts of a ground product of the burned product.

No particular limitation is imposed on the grinding method. Using a ball mill or the like, for example, the grinding can be effected in a usual manner. The ground product of the burned product may preferably have a Blaine specific surface area of from 2,500 to 5,000 cm²/g from the viewpoint of reducing bleeding from mortar or concrete and developing flowability and strength.

The cement according to the present invention can be obtained by mixing the above-described ground product of the burned product as much as 5 to 100 parts by weight, preferably 25 to 70 parts by weight per 100 parts by weight of a ground Portland cement clinker.

In addition, gypsum can be added to the cement according to the present invention. To the cement, gypsum can be added in a proportion of preferably from 1.5 to 5 wt. %, especially from 2 to 3.5 wt. %, specifically from 2.5 to 3 wt. % as calculated in terms of whole SO₃, because the resulting gypsum-added cement is provided with general setting properties. No particular limitation is imposed on the gypsum. Illustrative are dihydrate gypsum, α- or β-hemihydrate gypsum, type III anhydrous gypsum, and type II anhydrous gypsum. They can be used either singly or in combination.

The cement according to the present invention can be produced by mixing the above-described components together, and no particular limitation is imposed on the production process. For example, the processing components such as Portland cement clinker, the burned product and gypsum can be ground after mixing them together, or can be mixed together after separately grinding them. The cement can be produced by mixing the cement admixture, which has been obtained by grinding the burned product and gypsum, with a ground cement clinker. The cement obtained as described above may preferably have a Blaine specific surface area of from 2,500 to 4,500 cm²/g from the viewpoint of reducing bleeding from mortar or concrete and developing flowability and strength.

### EXAMPLES

The present invention will next be described in further detail based on examples, although the present invention shall by no means be limited by the following examples.

### Example 1

Burned products of the compositions shown in Table 1 and cements containing them were produced. With respect to each of the cements so obtained, the mortar compression strength (after 3 days, 7 days and 28 days) and setting time were measured in accordance with JIS R 5201. The results are shown in Table 1 and Table 2.

(Production Process)

(1) Production of the Burned Products

Using, as raw materials, a waste such as coal ash, incineration ash of sewage sludge or waste glass and a general Portland cement clinker raw material such as limestone, those raw materials were proportioned to give each predetermined mineral composition. The proportioned raw materials were clinkered through a small rotary kiln to obtain the burned product. Upon conducting the clinkering, waste plastics and waste oil were used as fuel in addition to general fuel oil, and the burning temperature was controlled at 1,250 to 1,500° C. to give a free lime amount of from 0.4±0.1%.

(2) Production of the Cements

Using normal Portland cement clinker (product of Taiheiyo Cement Corporation) as a clinker and flue-gas dihydrate gypsum (product of Sumitomo Metal Industries, Ltd.) as gypsum, they were mixed with the respective burned products in the proportions shown in Table 1 or Table 2. Those components were simultaneously mixed in a batch ball mill to give a Blaine specific surface area of 3250±50 cm²/g, thereby producing the cements.

TABLE 1

| | Composition of burned | | | Mixing | | | | | |
|---|---|---|---|---|---|---|---|---|---|
| | product (parts by | | | percentage | Amount of | Mortar compressive | | | |
| | weight) | | | of burned | gypsum | strength (N/mm²) | | | |
| No. | C₂S | C₃A | C₄AF | product* | (SO₃ %) | Day 3 | Day 7 | Day 28 | Remarks |
| 1 | — | — | — | — | 2.0 | 29.2 | 44.2 | 63.8 | |
| 2 | 100 | 75 | 75 | 43 | 2.0 | 19.8 | 27.2 | 43.2 | Insuf. initial |
| | | | | | | | | | strength |
| 3 | 100 | 25 | 125 | 43 | 2.0 | 17.2 | 25.1 | 44.7 | Insuf. initial |
| | | | | | | | | | strength |
| 4 | 100 | 100 | 0 | 43 | 2.0 | 21.8 | 30.7 | 45.8 | |
| 5 | 100 | 50 | 50 | 43 | 2.0 | 20.9 | 30.7 | 46.3 | |
| 6 | 100 | 0 | 100 | 43 | 2.0 | 20.1 | 30.5 | 61.2 | |
| 7 | 100 | 35 | 35 | 43 | 2.0 | 23.0 | 36.7 | 58.1 | |
| 8 | 100 | 20 | 20 | 43 | 2.0 | 24.8 | 39.2 | 61.0 | |
| 9 | 100 | 12.5 | 12.5 | 43 | 2.0 | 25.7 | 40.4 | 62.8 | |
| 10 | 100 | 5 | 5 | 43 | 2.0 | 28.7 | 41.2 | 64.3 | |
| 11 | 100 | 0 | 0 | 43 | 2.0 | 26.3 | 40.1 | 65.7 | Difficult to |
| | | | | | | | | | clinker |
| 12 | 100 | 35 | 35 | 5 | 2.0 | 28.5 | 43.9 | 64.6 | |
| 13 | 100 | 35 | 35 | 10 | 2.0 | 27.7 | 43.7 | 64.2 | |
| 14 | 100 | 35 | 35 | 25 | 2.0 | 27.1 | 43.5 | 63.6 | |
| 15 | 100 | 35 | 35 | 65 | 2.0 | 20.4 | 31.2 | 51.8 | |
| 16 | 100 | 35 | 35 | 100 | 2.0 | 17.6 | 28.4 | 45.2 | |

| | | | | | | |
|---|---|---|---|---|---|---|
| 17 | Limestone | 5 | 2.0 | 27.5 | 41.0 | 59.6 |
| 18 | | 10 | 2.0 | 26.0 | 39.5 | 56.1 |
| 19 | | 25 | 2.0 | 23.4 | 33.6 | 46.9 |
| 20 | | 45 | 2.0 | 21.2 | 28.4 | 37.3 |
| 21 | | 65 | 2.0 | 18.5 | 23.7 | 28.4 |
| 22 | | 100 | 2.0 | 16.2 | 18.2 | 20.1 |
| 23 | | 150 | 2.0 | 12.1 | 12.8 | 13.6 |
| 24 | Blast furnace slag | 5 | 2.0 | 27.2 | 42.1 | 62.0 |
| 25 | | 10 | 2.0 | 25.3 | 41.1 | 61.2 |
| 26 | | 25 | 2.0 | 22.3 | 37.2 | 59.8 |
| 27 | | 45 | 2.0 | 19.7 | 33.6 | 58.7 |
| 28 | | 65 | 2.0 | 16.8 | 29.5 | 57.2 |
| 29 | | 100 | 2.0 | 14.5 | 25.4 | 55.0 |
| 30 | | 150 | 2.0 | 11.0 | 22.0 | 52.1 |

*parts by weight per 100 parts by weight of Portland cement clinker

TABLE 2

| | | | | Mixing | | | | |
|---|---|---|---|---|---|---|---|---|
| | | | | percent- | Amount | | | |
| | Composition of burned product | | | age of | of | Setting | | |
| | (parts by weight) | | | burned | gypsum | Amount | Initial | Final |
| No. | C₂S | C₃A | C₄AF | product* | (SO₃ %) | of water (%) | (hr) | (hr) |
| 1 | — | — | — | — | 2.0 | 24.0 | 2:05 | 3:00 |
| 7 | 100 | 35 | 35 | 43 | 2.0 | 27.0 | 2:10 | 3:05 |
| 12 | 100 | 35 | 35 | 5 | 2.0 | 24.6 | 2:00 | 3:05 |
| 13 | 100 | 35 | 35 | 10 | 2.0 | 25.1 | 2:05 | 3:00 |
| 14 | 100 | 35 | 35 | 25 | 2.0 | 25.9 | 2:00 | 3:05 |
| 15 | 100 | 35 | 35 | 65 | 2.0 | 27.6 | 1:55 | 2:55 |
| 16 | 100 | 35 | 35 | 100 | 2.0 | 28.4 | 1:50 | 2:55 |
| 31 | 100 | 35 | 35 | 43 | 2.5 | 26.4 | 2:15 | 3:00 |
| 32 | 100 | 35 | 35 | 43 | 3.0 | 26.0 | 2:20 | 3:05 |
| 33 | 100 | 35 | 35 | 43 | 3.5 | 25.2 | 2:25 | 2:55 |
| 34 | 100 | 35 | 35 | 43 | 4.0 | 24.6 | 2:35 | 3:05 |
| 35 | 100 | 35 | 35 | 43 | 4.5 | 24.3 | 2:40 | 3:05 |
| 36 | 100 | 35 | 35 | 43 | 5.0 | 23.9 | 2:45 | 3:10 |
| 37 | 100 | 35 | 35 | 43 | 5.5 | 23.7 | 2:55 | 3:20 |

*parts by weight per 100 parts by weight of Portland cement clinker

From the results of Table 2, it is appreciated that the setting time tends to become faster with the mixing percentage of the burned product but can be controlled by the addition of gypsum.

### Example 2

Burned products and cement admixtures of the compositions shown in Table 3 and cements containing them were produced. With respect to each of the cements so obtained, the mortar compressive strength (after 3 days, 7 days and 28 days) and setting time were measured in accordance with JIS R 5201. The results are shown in Table 3.

(Production Process)

(1) Production of the Cement Admixtures

In a similar manner as in Example 1(1), the burned products of the compositions shown in Table 3 were produced. They were mixed with dihydrate gypsum (product of Sumitomo Metal Industries, Ltd.) such that the amounts of SO₃ in the cement admixtures would become the corresponding amounts shown in Table 3. The resulting mixtures were separately ground in a batch ball mill to give a Blaine specific surface area of 3250 cm²/g, thereby obtaining the cement admixtures.

(2) Production of the Cements

The cements were produced by mixing the respective cement admixtures in the corresponding proportions, which are shown in Table 3, with 100 parts by weight of the cement of No. 1 in Table 1.

TABLE 3

| | Composition of burned | | | | Mixing | | | | Setting | | |
|---|---|---|---|---|---|---|---|---|---|---|---|
| | product (parts by | | | SO₃ % in | percentage | Mortar compressive | | | Amount | | |
| | weight) | | | admixture | of | strength (N/mm²) | | | of water | Initial | Final |
| No. | C₂S | C₃A | C₄AF | (%) | admixture* | Day 3 | Day 7 | Day 28 | (%) | (hr) | (hr) |
| 38 | 100 | 35 | 35 | 2.0 | 5 | 28.0 | 43.5 | 65.1 | — | — | — |
| 39 | 100 | 35 | 35 | 2.0 | 10 | 27.0 | 43.2 | 64.0 | 25.1 | 2:05 | 3:00 |
| 40 | 100 | 35 | 35 | 2.0 | 25 | 26.2 | 42.0 | 64.0 | 26.0 | 2:00 | 3:00 |
| 41 | 100 | 35 | 35 | 2.0 | 43 | 21.8 | 35.8 | 61.0 | 27.0 | 2:05 | 3:05 |
| 42 | 100 | 35 | 35 | 2.0 | 65 | 19.5 | 30.5 | 54.8 | — | — | — |
| 43 | 100 | 35 | 35 | 2.0 | 100 | 16.0 | 26.2 | 50.2 | — | — | — |
| 44 | 100 | 35 | 35 | 3.0 | 43 | 23.2 | 36.9 | 59.0 | — | — | — |
| 45 | 100 | 35 | 35 | 4.0 | 43 | 24.0 | 37.3 | 58.0 | — | — | — |

*parts by weight per 100 parts by weight of the cement

### INDUSTRIAL APPLICABILITY

Use of the cement admixture, which has been obtained by grinding the burned product of the present invention, makes it possible to obtain a cement good in both initial strength and long-term strength. As the cement mixture obtained by grinding the burned product of the present invention is high in hydration reactivity, it can control the neutralization of mortar or concrete at low level. Coupled with abundant interstitial phases (C₃A, C₄AF), it has a relatively large heat of hydration and is also advantageous for use in cold districts and winter.

Moreover, the burned product of the present invention can be produced using, as a raw material, industrial wastes, non-industrial wastes, or surplus soil from construction sites, thereby making it possible to promote the effective utilization of wastes.

1. A burned product comprising 100 parts by weight of C₂S and 10 to 100 parts by weight in total of C₃A and C₄AF.

2. The burned product according to claim 1, which has been obtained using as a raw material at least one material selected from an industrial waste, a non-industrial waste or surplus soil from a construction site.

3. The burned product according to claim 1 or 2, which has been obtained by conducting burning at 1,000 to 1,350° C.

4. A cement admixture obtained by grinding a burned product according to any one of claims 1-3.

5. A cement admixture comprising 100 parts by weight of a ground product of a burned product according to any one of claims 1-3 and 1 to 6 parts by weight of gypsum as calculated in terms of SO₃.

6. A cement comprising 100 parts by weight of a ground Portland cement clinker and 5 to 100 parts by weight of a burned product according to any one of claims 1-3.

7. The cement according to claim 6, further comprising 1.5 to 5 wt. % of gypsum as calculated in terms of SO₃.
